(19) United States
(12) Patent Application Publication
(10) Pub. No.: US 2010/0325155 A1
(43) Pub. Date: Dec. 23, 2010

(54) Systems and Methods for Providing Access to Various Files Across a Network

(76) Inventors: James Skinner, Singapore (SG); Michael Hewitt, South Jordan, UT (US); Douglas Weber, Salt Lake City, UT (US); Gilbert Reimschussel, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/490,263

(22) Filed: Jun. 23, 2009

(51) Int. Cl. G06F 17/30; G06F 15/16

(52) U.S. Cl. 707/770; 709/201; 709/224; 707/912; 707/955; 707/822

(57) ABSTRACT

Systems and methods for providing access to an information stream in a format customized for a receiving device involve a network-based information storage and distribution system for receiving, storing, and distributing an information stream to a user of the information stream over a network. The system receives media files and converts the media files into multiple formats. When a user attempts to access the media files, such as by browsing a site containing the media files or clicking on a link to the media files, a determination is made as to the type of device attempting to access the files. A database of devices and what file formats, resolutions, codecs, etc., they support is consulted to select a file format suitable for that device. Then, the selected media files are displayed or made available for download or transmission to the user's device in a format compatible with the particular device.

### BACKGROUND OF THE INVENTION

1. Field of the Invention

The present invention relates to providing access to various files across a network, and more particularly to systems and methods for providing access to files in a format customized for a receiving device.

2. Background and Related Art

Many Internet sites, such as YouTube, Scribd, YouPublish, Posterous and other such systems provide a mechanism for users to post content, such as videos, audios, photos, or documents to the Internet. Other Internet sites, such as I-Tunes or Hulu offer various media files for users to consume online or to download for consumption locally on their computers or other consumer devices.

Users may seek to access this content from a wide variety of devices, such as personal computers or cell phones with Internet browsers installed in them. Typically, these sites convert the files that are uploaded from their various users into Flash or other commonly-recognized formats, or attempt to select a commonly-used format, such as .mp3 files for audio or .mp4 files for video, for uploading media content. YouPublish further allows download of the original unconverted file. These sites may use style sheets to ensure that information is correctly displayed on a variety of browsers, such as Internet Explorer, Safari, Firefox, Opera, etc. Some sites such as Scribd convert the files into multiple formats and give users a choice of what format to download, such as .pdf, .doc, or .txt files.

Many devices with which users may seek to access an information feed, such as cell phone devices or other portable devices like the Amazon book reader, Kindle, support only a limited range of file formats for viewing. These supported file formats are not common across devices. Some cell phones, for example, support .mp3 audio files, while others require .3gp audio files, and still others require .amr or .3g2 audio files.

The existing sites do not provide a system for users to upload content and for it to be easily viewable by a wide variety of cell phone or mobile devices that require different formats. Even systems that provide conversion of uploaded documents into multiple file formats require the user to make a selection, which is based on the user knowing what formats their devices support. Many users of cell phones and other mobile devices do not know what formats their devices support, so even after users download files, they may be unable to view the downloaded files. Existing media sites that permit users to upload their own content and attempt to choose a commonly-accepted media type encounter the same problem limiting the number and type of devices which may access and consume content from that site. Some sites, such as I-Tunes may even require the user to install software locally on their computers to access the site and make use of the sites' media files.

### BRIEF SUMMARY OF THE INVENTION

Implementation of the invention provides systems and methods for providing access to media files in a format customized for a receiving device. Implementation of the invention involves a network-based information storage and distribution system for storing and distributing the media files to users of the files over a network. In one implementation, the system receives upload of content from users and converts the file into multiple formats. In such implementations, the system includes a means of receiving upload of media files from users across a network.

When a user attempts to access the content, such as by browsing the site where the content is uploaded or posted, or by clicking on a link to the content, a determination is made as to the type of device attempting to access the content, and/or its configuration. A database of devices and what file formats, resolutions, codecs, etc., they support is then consulted to select a file suitable for that device and/or configuration. Then, the selected content is displayed or made available for download or transmission, such as by e-mail or instant messaging, to the user's device in a format compatible with the particular device and/or configuration, or by streaming, progressive download, or download to the user's access device in a format compatible with that particular device and/or configuration.

The system is implemented across one or more network-connected devices, such as servers, server clusters, or the like. This provides a network-connected information storage and distribution system for receiving, storing, and distributing files to a user of the files over a network. Some implementations may be configured to accept upload of files in various formats (e.g. in various formats ready for access requests by various devices) by the system operator or to accept upload from the system operator of files followed by system conversion of uploaded files into other formats to facilitate user access of the files. As content may be posted in a variety of formats, those implementations of the system that support upload of content from various users may be configured to modify or convert posts from their original format to one or more other formats to facilitate access by the user of the files and/or posts. This conversion and/or selection of what file format (whether a converted format or one of one or more original formats) is to be provided for download may be based on one or more factors, including a hardware and/or software configuration of the devices to be used to access the content and a communication speed of the connection between the system and the devices to be used to access the content. The content may be converted into various formats as it is received, or it may be converted on demand as the content is delivered to the users.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer environment for use with embodiments of the invention;

FIG. 2 shows a representative network environment for use with embodiments of the invention;

FIG. 3 shows a depiction of an embodiment of a system for providing access to media files in a format customized for a receiving device;

FIG. 4 shows an alternate depiction of an embodiment of a system for providing access to media files in a format customized for a receiving device; and

FIG. 5 provides a flowchart depicting a process for providing access to media files in a format customized for a receiving device.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for providing access to media files in a format customized for a receiving device. Embodiments of the invention involve a network-based information storage and distribution system for storing and distributing the media files to users of the files over a network. In some embodiments, the system receives upload of content from users and converts the file into multiple formats. In such embodiments, the system includes a means of receiving upload of media files from users across a network.

When a user attempts to access the content, such as by browsing the site where the content is uploaded or posted, or by clicking on a link to the content, a determination is made as to the type of device attempting to access the content, a characteristic thereof, and/or the device's configuration. The determination may be made by any method, such as receiving a user access device characteristic from the user at a time of subscription to an information stream comprising multiple media files or at a time of registration to use the system, receiving a user access device characteristic from the user at a time of requesting access to a media file, detecting a user access device characteristic by pinging the user access device, detecting a user access device characteristic by pinging the user's browser, detecting a user access device characteristic from device information included in a communication sent from the user access device, detecting a user access device characteristic based on the network or IP address from which the access request is received, detecting a user access device characteristic based on an error generated in attempting to view a media file of an unsupported type, and detecting a user access device characteristic based on the carrier or communications provider from which the access request is received.

A database of devices and what file formats, resolutions, codecs, etc., they support is then consulted to select a file suitable for that device and/or configuration. Then, the selected content is displayed or made available for download or transmission, such as by e-mail or instant messaging, to the user's device in a format compatible with the particular device and/or configuration, or by streaming, progressive download, or download to the user's access device in a format compatible with that particular device and/or configuration.

The system is embodied across one or more network-connected devices, such as servers, server clusters, or the like. This provides a network-connected information storage and distribution system for receiving, storing, and distributing files to a user of the files over a network. Some embodiments may be configured to accept upload of files in various formats (e.g. in various formats ready for access requests by various devices) by the system operator or to accept upload from the system operator of files followed by system conversion of uploaded files into other formats to facilitate user access of the files. As content may be posted in a variety of formats, those embodiments of the system that support upload of content from various users may be configured to modify or convert posts from their original format to one or more other formats to facilitate access by the user of the files and/or posts. This conversion and/or selection of what file format (whether converted or one of one or more original formats) is to be provided for download may be based on one or more factors, including a hardware and/or software configuration of the devices to be used to access the content and a communication speed of the connection between the system and the devices to be used to access the content. The content may be converted into various formats as it is received, or it may be converted on demand as the content is delivered to the users.

Although a portion of the discussion provided herein describes embodiments where an e-mail is used to facilitate access to files or other content, it should be understood that embodiments of the invention embrace many types of communications facilitating access to files or content, including files or content delivered via a browser. For example, embodiments of the invention enable files and content to be delivered via links provided using short message service (SMS) messages, multimedia message service (MMS) messages, and text messages (texts) or any other form of communication or notification. Additionally, where e-mail addresses are referred to herein, it should be understood that any unique user identifier and/or other information may be used to identify a user and direct notifications to that user. As one example only, the user's cell phone number may be used as an identifier and notifications may be sent to the user's cell phone using the cell phone number. As new communications methods emerge, it is anticipated that embodiments of the invention can be adapted to such communication methods.

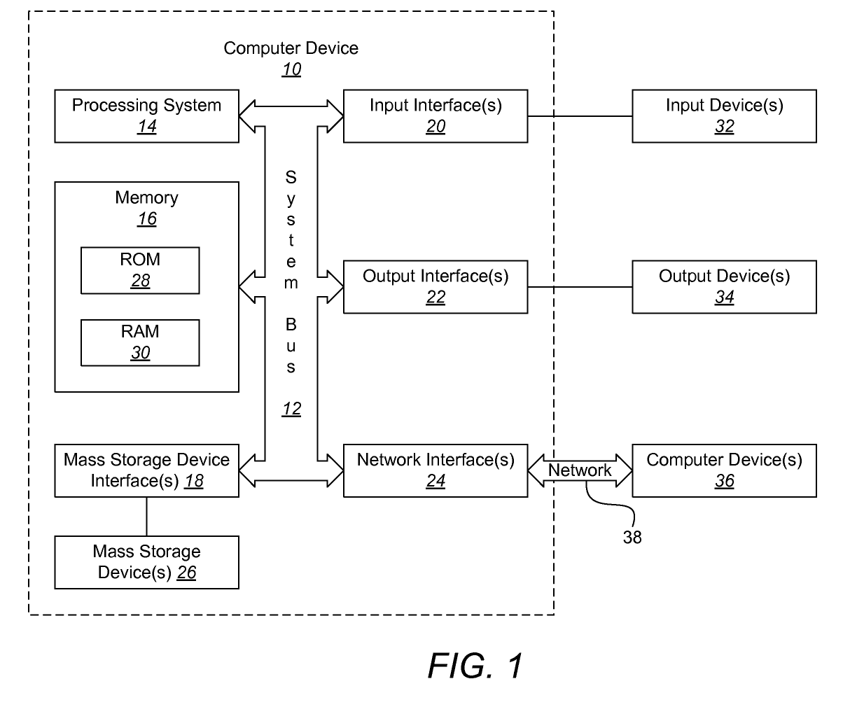

As embodiments of the invention embrace the use of network-connected consumer electronic devices and various network-connected computer devices, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer, or a consumer electronic device. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, flash memory drives, and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

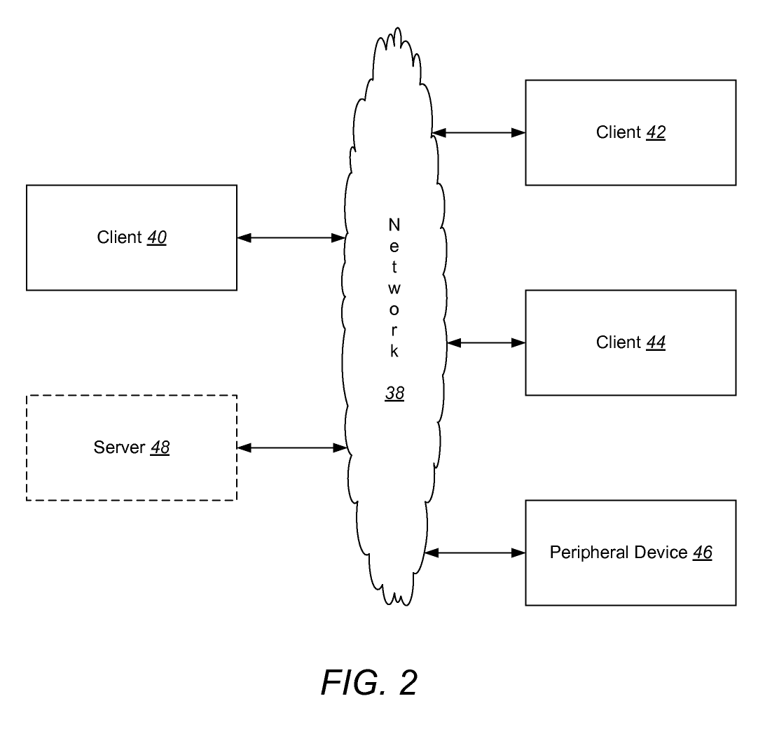

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Each of the clients 40, 42, or 44, or client computer devices can be any of a wide range of computer and consumer devices configured for connection to the network 38. Non-limiting examples of such devices include cell phones, smart phones, netbooks, laptops, tablet computers, personal/desktop computers running any of a variety of operating systems, workstations, personal data assistants (PDAs), electronic readers, wireless reading devices, e-book readers, or any other current or future computer device configured for at least intermittent access to the network 38.

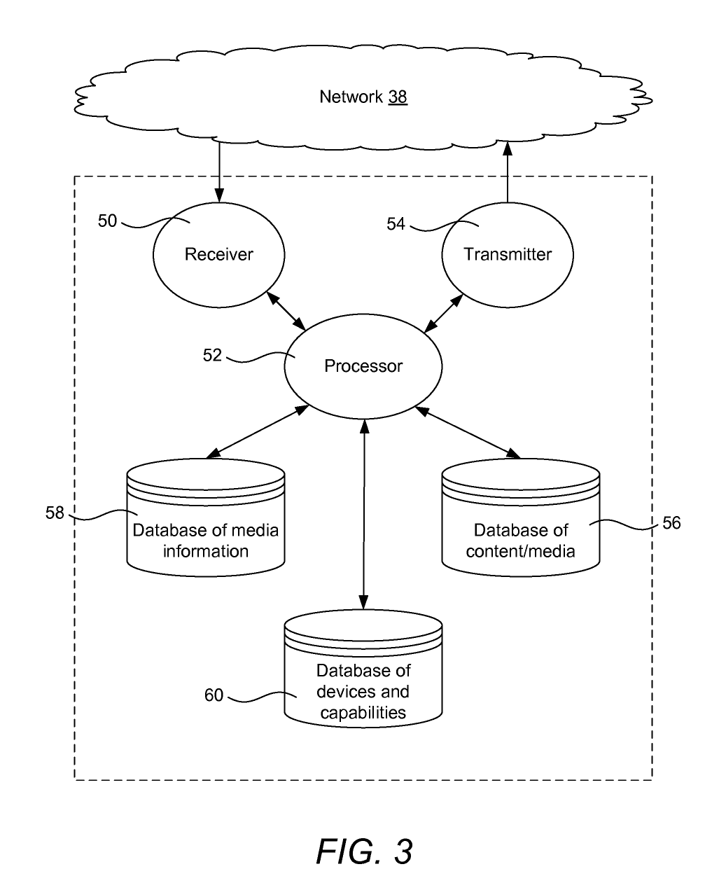

FIG. 3 shows one possible configuration of a network-connected system for storing and distributing media files to users of the files over a network. The system is connected to the network 38 and may be implemented across one or more or a variety of computer devices, including servers and the like. The system includes a receiver 50. The receiver 50 receives requests in any format over the network 38 from users. The requests can include requests to access content such as a media file stored on the system. The requests can take one of several formats, including an e-mail, a text message, a SMS message, a MMS message, a request received from a website supported by the system, selection of a link within a webpage, e-mail or other notification, a request provided by an application programming interface (API). Other types of requests that may be received by the receiver 50 include requests to post new media files or information on the system for access, as will be discussed further below, or any other request to interact with the system.

Regardless of the type of request, it is passed to a processor 52, which identifies the substance of the request by reference to information contained in the request. Where the request is a request for access to a media file stored on the system, the processor 52 identifies the media file on the system and delivers the media file to a transmitter 54 for transmission of the media file to the requesting user. If a password is required to access a particular media file, the processor 52 determines whether the password has been included in the request or requires the requesting user to submit the password before providing access to the requested media file. Where the request is other than a request for access to a media file, the processor 52 handles the request as appropriate.

The system stores media files in a database of content or media (“media database 56”), that may store a plurality of media files in a plurality of formats. The processor 52 may identify the media files stored in the media database 56 in a variety of manners. For example, the processor 52 may identify the media files by direct reference to the media database 56 to search for the media files as those files are requested. Alternatively, the processor may reference an index or a database of media information (“media information database 58”) storing information regarding the media files, their storage location and/or filename, etc. on the media database 56. Other methods and systems for identifying media files for delivery upon request are embraced by embodiments of the invention, and the described mechanisms are therefore merely illustrative, and not limiting.

Because of the wide variety of access devices (e.g. computer devices, consumer electronic devices such as electronic readers, cell phones, smart phones and the like) may be used to seek access to the media files through the system, the system includes the capability to deliver access to the media files in formats compatible with the access devices. Accordingly, the system includes a database of access devices and capabilities (“access device characteristics database 60”). The access device characteristics database 60 stores information relating to characteristics of various access devices that are used by the system to determine how the media files should be formatted to facilitate access to the media files. Such information may include a type of the user access device, a manufacturer of the user access device, a model of the user access device, a hardware configuration of the user access device, a software configuration of the user access device, a combined hardware and software configuration of the user access device, and/or file formats, resolutions, and/or codecs supported by the user access device. Such information may be stored for any or all of a variety of user access devices, such as a cell phone; a smart phone; a netbook; a laptop computer; a tablet computer; a desktop computer; a workstation; a personal digital assistant (PDA); an electronic reader; and a wireless reading device.

The processor 52 utilizes the access device characteristics database 60 to determine which media file to provide access to upon a request for a media file and/or to determine how a media file should be converted so as to facilitate access to the media file for the requesting user's access device. When media files are loaded into the system (either by a posting user or by a system administrator), they may be stored in their original format in which they were received, and/or they may optionally be converted into one or more other formats and stored in the other format or formats. For example, a media file uploaded to the system may be uploaded in a non-standard format. The system (e.g. the processor 52) may convert such a file into one or more more-standard formats to facilitate distribution and access to the media file, and the media file may be stored in such format(s) in addition to or in lieu of the original format in the media database 56. The formats in which the media file is available may be stored in the media information database 58. Even when the media file is converted into one or more more-standard formats, the converted formats may not be compatible with a particular access device, so the system permits further conversions to occur to provide the media file to a compatible format. Such further conversions may be performed at the time of file upload, at the time of a file access request, or at an intermediate time.

Access to the file in the compatible format may be provided using many different methods. In some instances, an e-mail sent by the transmitter 54 includes a link to access the media file, or a link to a page having additional links to the media file or one or more components thereof (e.g. direct linking and/or indirect linking). In other instances, the media file itself is contained in the body of an e-mail or as an attachment thereto. Regardless of how content is delivered to the user (as a link within the e-mail or delivered with the e-mail itself, or by some other mechanism), the media file is provided in a format that facilitates access by the user. The provided format may also take into account communication speeds between the system and the users' access devices. For example, many cell phones have varying communications rates, and the communications rate of an individual cell phone may vary depending on a cell phone user's location within a cell phone network. If a video is originally posted in lossless high definition (HD) format, it may be undesirable to deliver the video in that format to a user's cell phone over a slow network. If, however, the video is first converted to a lower resolution and compressed format, the cell phone may be better able to receive and display the video in a meaningful way to the user. For example, the resolution capable of being displayed on the device may be determined and a resolution smaller to or equal to this resolution is selected.

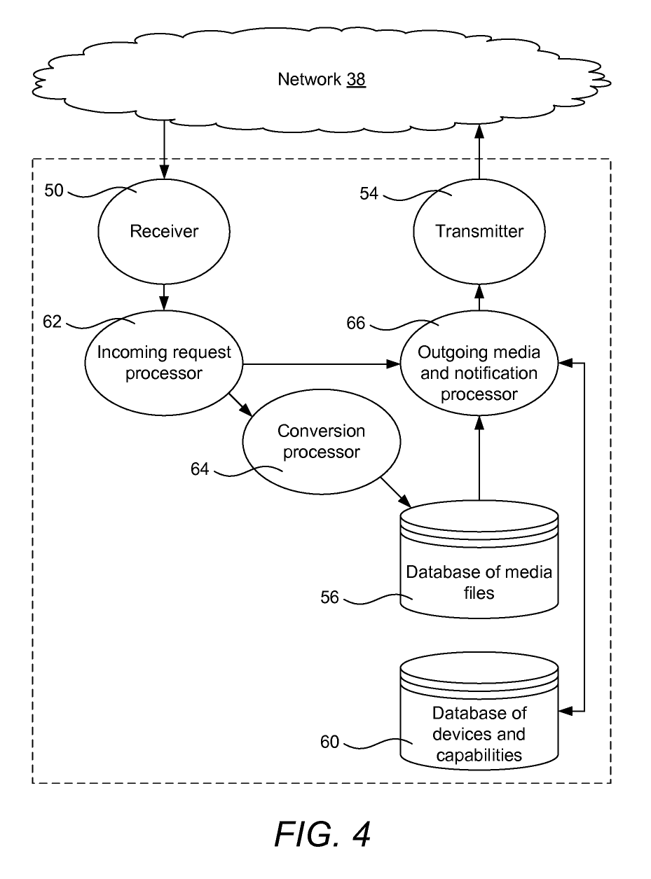

FIG. 4 displays an alternate embodiment or depiction of a network-connected system for storing and distributing media files to users of the files over a network. In this embodiment, the system includes an incoming request processor 62 that handles incoming requests received by the receiver 50. The incoming requests may include requests to subscribe to a content stream containing one or more media files, requests to unsubscribe to a content stream, requests from content-posting users to post content (e.g. media files), requests to cancel an account (either from a user or a content-posting user), requests for support, reports of abuse, or any other type of incoming request. The incoming request processor 62 processes the requests and responds to the requests appropriately, executing the appropriate action according to the type of the incoming request.

The receiver 50 and the incoming request processor 62 receive the incoming requests using any of a variety of formats. E-mails may be received using the Internet message access protocol (IMAP) or any other protocol. Although many requests may be received by e-mail, other requests may be received and handled by the incoming request processor 62 by other mechanisms, including requests received from a web site interface (e.g. a form post or a link click to perform the request), and requests received through an application programming interface (API) such as of a third-party application sending the request. In at least some embodiments, any type of request can be received using any of the possible request avenues.

If the incoming request is a post request containing content, the content may be passed to a conversion processor 64. The conversion processor 64 serves to convert or modify the content in a way that facilitates user access. Although one conversion processor 64 is illustrated, it should be understood that multiple or many conversion processors 64 may be used to convert files of various types and formats (e.g. different conversion processors 64 may be used for images as opposed to videos, images of one file type as opposed to another type, etc.). The conversion processor 64 converts recognized incoming media into one or more of a variety of standard and targeted encodings, including resolutions, codecs, and compression settings. For example, a Word document may be converted to a PDF document or another targeted format. A high-resolution Quicktime movie may be converted into a lower resolution movie and/or to another format, such as .mp4 or .3gp. Such conversions facilitate an optimal consumption experience for the users of the media files, by making access to the media files either possible in the first place or simply more convenient.

The conversion processor 64 may provide the converted media files to the media database 56, where the converted media files may be accessed by an outgoing media and notification processor 66 for inclusion in notifications to be sent over the network 38 by the transmitter 60. Alternatively, the converted media files may be accessed by the user selecting a link on a website or in a notification as described above.

As the system is designed to facilitate user access to media files, the system may be configured to determine hardware and/or software configurations or modes of the user access device or to receive a notification from the user of such configurations or modes. In some embodiments, the system can detect the hardware and/or software configurations or modes, such as by using a user agent to detect a browser header. Another manner of detecting the hardware and/or software configurations or modes is by detecting device information included in e-mails sent by the user device, such as header information. Other manners of detecting a device characteristic of the hardware and/or software configuration include: receiving the user access device characteristic from the user at a time of subscription to an information stream comprising multiple media files or at a time of registration to use the system, receiving the user access device characteristic from the user at a time of requesting access to a media file, detecting the user access device characteristic by pinging the user access device, detecting the user access device characteristic by pinging the user's browser, detecting the user access device characteristic from device information included in a communication sent from the user access device, detecting the user access device characteristic based on the network or IP address from which the access request is received, detecting the user access device characteristic based on an error generated in attempting to view a media file of an unsupported type, and detecting the user access device characteristic based on the carrier or communications provider from which the access request is received.

By detecting the hardware and/or software configurations or modes, the system can deliver a file format that is supported for viewing on the user access device. To facilitate this delivery, the system maintains the access device characteristics database 60. The access device characteristics database 60 contains a list of devices on which posted media files could be consumed and associated device characteristics. This database includes information that improves the user's media files consumption experience, such as any of determining the proper encodings, file types, resolutions, compression codecs, etc. to present to the user access device.

When the user accesses media files or when the system attaches media files to a notification, the system (such as through the outgoing media and notification processor 66) determines the applicable hardware and/or software configurations or modes, references the access device characteristics database 60, and provides access to the media files in the media database 56 in a format determined to enhance and facilitate user access through the access device. This determination may also or alternatively take into account a connection or communication speed between the system and the access device, such that media files is timely delivered regardless of the communication speed. While any of a variety of factors may be considered when delivering access to the media files, non-limiting examples of some factors for consideration include: the make and model of the access device, information about how various user access devices are configured at the time of their manufacture or sale, information about the file formats, resolutions, or codecs that the manufacturer claims the device supports, information about the file formats that are supported as standard by a given carrier or communications provider and the access devices that are sold to users of that carrier or communications provider, the operating system of the device, access programs available on the device, the data transfer speed, the native screen resolution of the device, the browser being used, etc. Thus the media files may be delivered in a manner that is more convenient and enjoyable to the user.

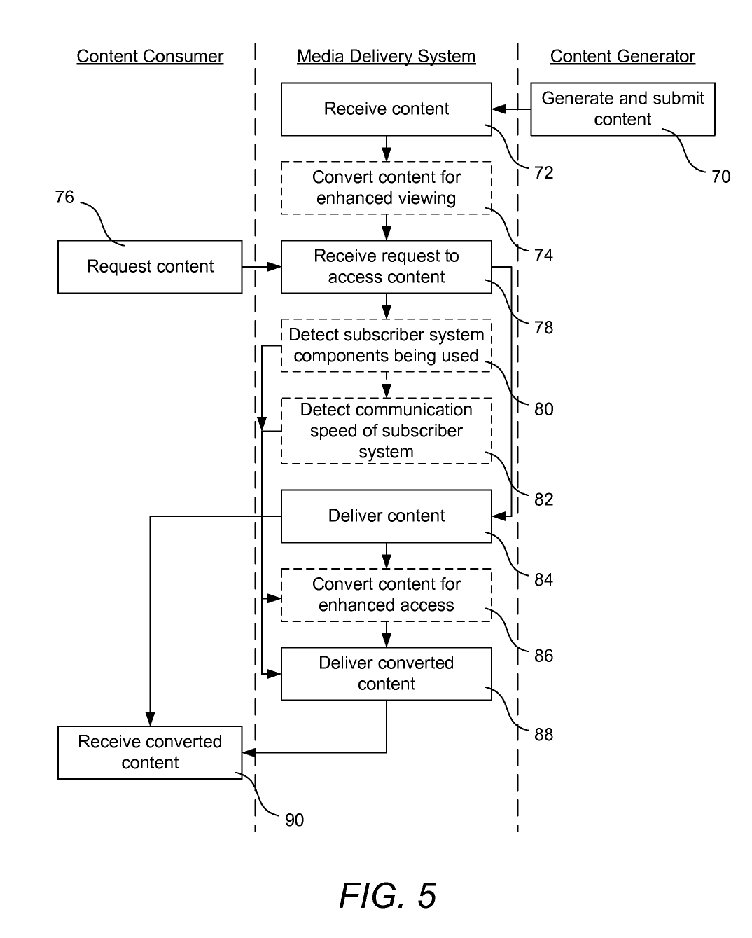

In some instances, media files may be converted into a variety of formats, encodings, resolutions, and the like, immediately upon receipt. In other instances, it may be desirable to convert or modify media files as needed, either at the time of sending notifications to users or at the time users attempt to access the media files. In still other instances, a hybrid approach may be used, where the media files is converted or partially converted into some formats, resolutions, and the like, immediately upon receipt and into other formats, resolutions, and the like, at a later time. Each time of conversion has certain advantages. Early conversion facilitates maximum speed of delivery to users upon request. Later conversion may avoid conversion into unneeded formats and may save storage space. Thus, different instances and different embodiments may opt for conversion at different times as is illustrated in the flow charts of FIG. 5.

FIG. 5 depicts an illustrative process for delivery of content (e.g. one or more media files) posted by a content generator (or a system administrator) on a system for storage and delivery of a variety of media files over a network. Execution begins at step 70, where the content generator generates and submits content. The system for storage and delivery of a variety of media files receives the content at step 72. The system may optionally convert content for enhanced viewing at step 74, as described above. Regardless of whether content is converted at step 74, execution proceeds to step 76, where a user requests to access the content, and the system receives the request to access the content at step 78.

The system may optionally detect or determine the user system components (e.g. hardware and/or software configuration or mode) being used at step 80 and may alternatively or additionally detect or determine a communication speed of the user system at step 82. If, however, no detection or determination occurs, the content is delivered at step 84.

If one or more of the detection/determining steps 80, 82 occurs, execution may proceed to either of steps 86 or 88, depending on whether the updated content is already in a format configured for an enhanced user experience. If the content either already is stored in a desired format (e.g. was received in that format at step 72) or has already been converted to an desired format at step 74, the content is delivered at step 88. If, however, the content should be converted to enhance the user experience, it is first converted at step 86 before being delivered by the system at step 88. Regardless of whether or when any conversion occurred, the content is received by the user at step 90 and is consumed by the user using the user's access device, whatever it may be.

As discussed above, the system is configured to detect hardware and/or software being used on the accessing device when the accessing device is used by the user to attempt to access content via a link in some embodiments. In some instances, however, the device hardware and/or software configuration or mode is one not included in the access device characteristics database 60. If the device hardware and/or software configuration or mode is not included in the access device characteristics database 60, the system stores and/or outputs the detected data on the device and/or software making the request to access content.

Such new device and configuration information can be used in various ways. In one example, the information is used to look up, research, or otherwise determine the capabilities of the device and its software so the system can provide content to the device in a format designed to enhance the user's experience. In another example, it may be determined that the number of users having configurations similar to those detected and added to the system do not merit supporting or fully supporting the detected configuration or mode, in which case partial support may be provided or the system may track the number of users having that configuration until that number justifies the resources to support or fully support the detected configuration or mode. In this way, the system can dynamically adjust to and support new devices and capabilities to enhance users' consumption experiences.

Systems and methods in accordance with the embodiments depicted and described herein may be useful in file distribution systems for distribution of media files from a plurality of users (e.g. content-generating users) to a plurality of other users (e.g. content consuming users). In such systems, content such as media files may be generated in a plurality of formats, and the content-generating users may not know in what format or formats potential content consuming users will want the media files. Instead of requiring each content generator to provide content directly to each potential content consumer, embodiments of the invention permit the content generator to upload the content to a centralized system, which handles all necessary conversions for the various content generators, and then delivers the converted content to content consuming users. The content consuming users may include a variety of users, such as subscribers to a particular content generator's content.

Thus, embodiments of the invention provide systems and methods for providing access to various media files in formats customized for a receiving device. The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. In a network-based information storage and distribution system for storing and distributing media files to users over a network, a method for providing access to the media files in a format customized for a receiving device comprising:
receiving a request to access a requested media file at a network-based information storage and distribution system from a user using a user access device;
determining a user access device characteristic comprising at least one of:
a type of the user access device;
a hardware configuration of the user access device;
a software configuration of the user access device; and
file formats, resolutions, and/or codecs supported by the user access device;
selecting a selected format in which to deliver the requested file to the user access device based on the user access device characteristic; and
providing access to the requested file to the user access device in the selected format.

2. A method as recited in claim 1, wherein the system comprises a database of access device characteristics, and wherein selecting a selected format comprises accessing the database of access device characteristics.

3. A method as recited in claim 2 wherein the database comprises information about how various user access devices are configured at the time of their manufacture or sale.

4. A method as recited in claim 2 wherein the database comprises information about the file formats, resolutions, or codecs that the manufacturer claims the device supports.

5. A method as recited in claim 2 wherein the database comprises information about the file formats that are supported as standard by a given carrier or communications provider and the access devices that are sold to users of that carrier or communications provider.

6. A method as recited in claim 2 wherein the database comprises various devices and the file formats, resolutions, and/or codecs that should be selected when a request is received from that device type for at least one of the following media types:
video;
audio;
text; and
images.

7. A method are recited in claim 2 wherein files are converted into a number of formats and the devices in the database are correlated to the best resolution and format for each particular device from among the resolutions and formats that are provided by a file converter, wherein the a resolution provided by the converter is compared with the resolution capable of being displayed on the device and a resolution smaller to or equal to this resolution is selected.

8. A method as recited in claim 1, further comprising:
receiving a plurality of media files from a plurality of users by upload; and
storing the plurality of media files in the information storage and distribution system.

9. A method as recited in claim 8, wherein the selected format differs from a received format in which at least a portion of the plurality of media files was received by the system.

10. A method as recited in claim 9, further comprising converting the selected file from the received format to the selected format.

11. A method as recited in claim 10, wherein the selected file is converted from the received format to the converted format at the time the selected file is received by the system.

12. A method as recited in claim 10, wherein the selected file is converted from the received format to the converted format at a time when the selected file is requested by the user.

13. A method as recited in claim 10, wherein the selected file is converted from the received format to an intermediate format at the time the selected file is received by the system and wherein the selected file is converted from the intermediate format to the converted format at a time when the selected file is requested by the user.

14. A method as recited in claim 8, wherein the media files are stored in the information storage and distribution system in a variety of formats corresponding to one or more formats indicated as being supported by user access devices in the database of access device characteristics.

15. A method as recited in claim 1, further comprising converting the selected file from a format in which it is stored to the selected format after selecting the selected format.

16. A method as recited in claim 1, wherein determining a user access device characteristic comprises at least one of:
receiving the user access device characteristic from the user at a time of subscription to an information stream comprising multiple media files;
receiving the user access device characteristic from the user at a time of registration to use the system;
detecting the user access device characteristic by pinging the user access device;
detecting the user access device characteristic by pinging the user's browser;
detecting the user access device characteristic from device information included in a communication sent from the user access device;
detecting the user access device characteristic based on a network from which the access request is received;
detecting the user access device characteristic based on an IP address from which the access request is received;
detecting the user access device characteristic based on the carrier or communications provider from which the access request is received;
detecting a user access device characteristic based on an error generated in attempting to view a media file of an unsupported type; and
receiving the user access device characteristic from the user at a time of requesting to access the selected file.

17. A method as recited in claim 1, further comprising detecting a communication speed between the system and the user access device, wherein selecting a selected format is further based on the communication speed.

18. A method as recited in claim 1, wherein selecting a selected format comprises selecting a format that is suitable for the user access device characteristic.

19. A method as recited in claim 1, wherein the user access device is one of:
a cell phone;
a smart phone;
a netbook;
a laptop computer;
a tablet computer;
a desktop computer;
a workstation;
a personal digital assistant (PDA);
an electronic reader; and
a wireless reading device.

20. A method as recited in claim 1, further comprising maintaining a database of user access devices and file formats supported on each user access device for use in selecting one of the formats based on the determined configuration of the user access device.

21. A method as recited in claim 1, further comprising maintaining a database of user access device capabilities containing:
user access device capabilities selected from the group of:
hardware capabilities;
software capabilities; and
hardware and software capabilities; and
information identifying how the media files should be formatted to enhance a user consumption experience based on the user access device capabilities.

22. A method as recited in claim 21, further comprising:
determining that the user access device characteristic is not included in the database of user access device capabilities;
adding the user access device characteristic to the database of user access device capabilities;
identifying how the information stream should be formatted to enhance the user consumption experience for the user access device characteristic; and
adding how the information stream should be formatted to enhance the user consumption experience for the user access device characteristic to the database of user access device capabilities.

23. A method as recited in claim 1, wherein providing access to the requested file to the user access device in the selected format occurs by one of:
download of the requested file to the user access device;
an e-mail to the user access device containing the requested file;
an instant message to the user access device containing the requested file;
a progressive download of the requested file to the user access device; and
streaming the requested file to the user access device.

24. In a network-based information storage and distribution system for receiving, storing, and distributing user-posted media files to a user of the media files over a network from one or more network-connected servers, a method for providing access to a selected media file in a format customized for a receiving user device comprising:
receiving a posted media file from a content-posting user;
storing the posted media file in a network-based information storage and distribution system;
receiving a request to access the posted media file from a requesting user using a user access device;
determining a user access device characteristic of the user access device comprising at least one of:
a type of the user access device;
a hardware configuration of the user access device;
a software configuration of the user access device; and
file formats, resolutions, and/or codecs supported by the user access device;
selecting a selected format in which to deliver the posted file to the user access device based on the user access device characteristic; and
providing access to the posted file to the user access device in the selected format, wherein the selected format is a format configured for access by the user access device.

25. A method as recited in claim 24, wherein providing access to the posted file comprises:
converting the posted file into a converted format designed to facilitate access to the posted file according to the user access device characteristic; and
delivering the posted file to the consumer device in the converted format.

26. A method as recited in claim 24, further comprising determining a communications speed between the system and the user access device, wherein converting the posted file into a converted format takes into account the communications speed.
